(19) United States
(12) Patent Application Publication
(10) Pub. No.: US 2024/0358568 A1
(43) Pub. Date: Oct. 31, 2024

(54) MATTRESS FOR A PATIENT SUPPORT APPARATUS

(71) Applicant: UMANO MEDICAL INC., L'Islet (CA)

(72) Inventors: Sylvain LACASSE, Québec (CA); Pascal POULIN, St-Lambert-de-Lauzon (CA); André GUILLEMETTE, Lévis (CA); Montassar BEN ABDALLAH, Lévis (CA); Pierre-Luc NADEAU, Lévis (CA); Steve BOLDUC, Beaumont (CA); Audrey LAINÉ, Lévis (CA); Jasmine JOLY-DUMONT, Roxboro (CA); Martin LAVOIE, Lévis (CA); Philippe ROY, Québec (CA); Jérôme MARCOTTE, Lévis (CA); Daniel QUINTERO, Québec (CA); Claude BERNIER, Ste-Brigitte de Laval (CA); Josée ROBERGE, Ste-Brigitte de Laval (CA)

(21) Appl. No.: 18/641,515

(22) Filed: Apr. 22, 2024

Related U.S. Application Data
(60) Provisional application No. 63/498,068, filed on Apr. 25, 2023.

(51) Int. Cl. A61G 7/057; B29D 22/02; B29K 67/00; B29K 75/00; B29K 105/08; B29K 267/00; B29K 277/00

(52) U.S. Cl. CPC A61G 7/05776; A61G 7/05784; B29D 22/02; B29K 2067/00; B29K 2075/00; B29K 2105/0845; B29K 2267/00; B29K 2277/00; B29K 2995/0065

(57) ABSTRACT

A mattress for a patient support apparatus has a cover having bottom and top surfaces, and an inflatable section disposed between the bottom and top surfaces. The inflatable section has a plurality of upper bladders in fluid communication with each other and a plurality of lower bladders in fluid communication with each other. The upper and lower bladders are selectively inflated independently from each other. The upper and lower bladders are formed by three sheets including an upper sheet, a lower sheet disposed below the upper sheet, and an intermediate sheet disposed between the upper and lower sheets. The upper sheet is fixed to the intermediate sheet to define the upper bladders between the upper sheet and the intermediate sheet. The lower sheet is fixed to the intermediate sheet to define the lower bladders between the lower sheet and the intermediate sheet. Other aspects of the mattress are also disclosed.

### CROSS REFERENCE TO RELATED APPLICATIONS

The present application claims priority from U.S. Provisional Patent Application Ser. No. 63/498,068 filed Apr. 25, 2023, the contents of which are herein incorporated by reference in their entirety.

### FIELD OF TECHNOLOGY

The present technology relates to mattresses intended for use with patient support apparatuses such as hospital beds.

### BACKGROUND

A variety of mattresses are used in medical care settings, often in combination with a hospital bed, to offer patients a comfortable support surface. Some mattresses, such as those used in a hospital's intensive care unit (ICU), can have advanced functions to provide particular therapies to the patient and/or to assist the patient and medical personnel.

In many cases, such mattresses offer an alternating pressure function which alters the pressure points exerted on the patient's body by the mattress' inflatable bladders in order to prevent and/or treat pressure injuries. However, additional functions of the mattress may interfere with the alternating pressure function and/or reduce its performance. Moreover, improvements in air flow along the inflatable bladders can help prevent malfunctions and poor performance. Furthermore, a design of the mattress that optimizes cost reductions without compromising performance is particularly desirable given the significant costs associated with ICU mattresses.

Lastly, compatibility between the mattress and the corresponding hospital bed is particularly important in an ICU setting. For instance, an ICU hospital bed is capable of being placed in a chair egress position to help the patient get up from the bed, and therefore the mattress should be optimized for such movement.

In view of the foregoing, there is a need for a mattress that addresses at least some of these drawbacks.

### SUMMARY

It is an object of the present technology to ameliorate at least some of the inconveniences present in the prior art.

According to an aspect of the present technology, there is provided a mattress for a patient support apparatus, the mattress comprising: a cover having a bottom surface and a top surface, in use, the top surface facing a patient supported by the mattress; and an inflatable section disposed between the bottom surface and the top surface, the inflatable section comprising a plurality of bladders, the plurality of bladders comprising: a plurality of upper bladders in fluid communication with each other; and a plurality of lower bladders in fluid communication with each other, the upper bladders being selectively inflated independently from the lower bladders, the upper and lower bladders being formed by three sheets including an upper sheet, a lower sheet disposed below the upper sheet, and an intermediate sheet disposed between the upper and lower sheets, the upper sheet being fixed to the intermediate sheet to define the upper bladders between the upper sheet and the intermediate sheet, the lower sheet being fixed to the intermediate sheet to define the lower bladders between the lower sheet and the intermediate sheet.

In some embodiments, each of the upper and lower bladders is elongated in a lateral direction of the mattress.

In some embodiments, each of the upper and lower bladders spans a majority of a width of the mattress.

In some embodiments, the upper sheet is welded to the intermediate sheet at first weld sites to form the upper bladders; the lower sheet is welded to the intermediate sheet at second weld sites to form the lower bladders; and the first weld sites are longitudinally offset from the second weld sites.

In some embodiments, the first weld sites between any two consecutive ones of the upper bladders extend along a first axis, the upper sheet and the intermediate sheet being free of welds along at least a portion of the first axis to allow fluid communication between the two consecutive ones of the upper bladders; and the second weld sites between any two consecutive ones of the lower bladders extend along a second axis, the lower sheet and the intermediate sheet being free of welds along at least a portion of the second axis to allow fluid communication between the two consecutive ones of the lower bladders.

In some embodiments, the mattress further comprising: a pneumatic system comprising a pump unit in fluid communication with the upper and lower bladders; and the pneumatic system being operable to alternate a pressure within the upper and lower bladders to provide an alternating pressure function to the mattress.

In some embodiments, the mattress further comprises an inflatable support section disposed below the inflatable section; and the inflatable support section comprises a plurality of support bladders, the support bladders being pressurized independently from the upper and lower bladders.

In some embodiments, each of the upper and lower bladders has a first height measured at a maximum inflation thereof; each of the support bladders has a second height measured at a maximum inflation thereof; and the second height is greater than the first height.

In some embodiments, the first height is less than 5 inches.

In some embodiments, the mattress further comprises a structural form layer disposed beneath the inflatable support section.

In some embodiments, the mattress further comprises an air loss layer disposed between the inflatable section and the top surface, the air loss layer being configured to diffuse air toward the top surface.

In some embodiments, the air loss layer comprises a spacer sheet that is disposed above the upper sheet and is fixed thereto.

In some embodiments, the upper sheet is welded to the intermediate sheet at first weld sites to form the upper bladders; the lower sheet is welded to the intermediate sheet at second weld sites to form the lower bladders; the first weld sites are longitudinally offset from the second weld sites; the air loss layer is welded to the upper sheet at third weld sites; and the first weld sites and the third weld sites are superimposed.

According to another aspect of the present technology, there is provided a method for manufacturing a mattress for a patient support apparatus, the method comprising: providing three polymeric sheets including a first sheet, a second sheet and a third sheet; joining the first sheet to the second sheet along first joining sites to form at least in part a plurality of first bladders defined between the first sheet and the second sheet, the first bladders being in fluid communication with each other and positioned side-by-side in a given direction; and joining the third sheet to the second sheet along second joining sites that are offset from the first joining sites along the given direction thereby forming at least in part a plurality of second bladders defined between the third sheet and the second sheet, the second bladders being in fluid communication with each other and positioned side-by-side in the given direction.

In some embodiments, joining the first sheet to the second sheet comprises welding the first sheet to the second sheet, the first joining sites being first welding sites; joining the third sheet to the second sheet comprises welding the third sheet to the second sheet, the second joining sites being second welding sites; and the method further comprises: after welding the first sheet to the second sheet and prior to welding the third sheet to the second sheet, inserting a buffer between the first sheet and the second sheet to prevent welding the first sheet to the second sheet along the second welding sites; and after welding the third sheet to the second sheet, removing the buffer from between the first and second sheets.

In some embodiments, the method further comprises: after removing the buffer from between the first and second sheets, sealing at least one peripheral side of the first, second and third sheets, including a peripheral side through which the buffer was inserted between the first and second sheets.

In some embodiments, the method further comprises: joining a spacer sheet to the first sheet along the first joining sites or to the third sheet along the second joining sites in order to form air loss pockets from which, in use, air may be diffused.

In some embodiments, the spacer sheet comprises a 3D fabric.

In some embodiments, the spacer sheet is layered with a thermoplastic sheet; and the method further comprises: prior to joining the spacer sheet to the first sheet or the third sheet, making openings in the thermoplastic sheet through which, in use, air in the air loss pockets may traverse before being diffused through the spacer sheet.

According to another aspect of the present technology, there is provided a mattress for a patient support apparatus, comprising: a cover having a bottom surface and a top surface, in use, the top surface facing a patient supported by the mattress; an inflatable section disposed between the bottom surface and the top surface, the inflatable section comprising a first sheet and a second sheet disposed beneath the first sheet, the first and second sheets being joined together at first joining sites to form a plurality of bladders defined between the first and second sheets, the bladders being pneumatically inflatable; and an air loss layer disposed between the inflatable section layer and the top surface, the air loss layer comprising a spacer sheet that is joined to the first sheet of the inflatable section at second joining sites to form a plurality of air loss pockets configured to disperse air through the spacer sheet, wherein the first joining sites and the second joining sites are superimposed such that the spacer sheet generally conforms to a shape of the bladders.

In some embodiments, the bladders are selectively inflated and deflated to provide an alternating pressure functionality.

In some embodiments, the plurality of bladders is a plurality of upper bladders; the comfort layer further comprises a third sheet extending below the second sheet; and the third sheet is joined to the second sheet at third joining sites to form a plurality of lower bladders defined between the second sheet and the third sheet, the lower bladders being pneumatically inflatable.

In some embodiments, the third joining sites are at least partially offset from the first and second joining sites such that the first and second joining sites are not superimposed with the third joining sites; and the upper and lower bladders are alternatingly inflated and deflated to provide an alternating pressure functionality.

In some embodiments, the spacer sheet comprises a 3D fabric.

In some embodiments, the mattress further comprises a pneumatic system in fluid communication with the air loss pockets and is configured to control air flow through the air loss pockets; and the pneumatic system is operable to adjust an air flow rate through the air loss pockets.

In some embodiments, the pneumatic system is in fluid communication with the bladders and controls the pressurization of the bladders independently from the air flow through the air loss pockets.

In some embodiments, the pneumatic system further comprises at least one blower for directing air to the bladders and the air loss pockets.

In some embodiments, the patient support apparatus comprises a control unit configured to control the pneumatic system; and the pneumatic system is operable, responsive to a command from the control unit, to selectively start and stop dispersion of air through the spacer sheet.

In some embodiments, the top surface is impermeable to moisture and permeable to air.

According to another aspect of the present technology, there is provided a mattress for a patient support apparatus, comprising: a cover having a bottom surface and a top surface, in use, the top surface facing a patient supported by the mattress; and at least one inflatable section disposed between the bottom and top surfaces and configured to be selectively inflated, each of the at least one inflatable section comprising: a plurality of inflatable bladders in fluid communication with each other; and a spacer layer disposed within the inflatable bladders such that the spacer layer extends through consecutive ones of the inflatable bladders to at least partially space apart internal walls defining the inflatable bladders, the spacer layer being air permeable.

In some embodiments, the spacer layer is configured to diffuse air traversing therethrough in various directions.

In some embodiments, the spacer layer is a 3D fabric.

In some embodiments, the at least one inflatable section comprises a first sheet and a second sheet fixed to each other and together defining the inflatable bladders; each two consecutive ones of the inflatable bladders are in fluid communication with each other via a communication channel defined between the first and second sheets; and the spacer layer extends through each of the communication channels.

In some embodiments, the spacer layer is a strip having a width that is equal to or smaller than a width of each of the communication channels.

In some embodiments, each of the first sheet and the second sheet comprises a polymeric material.

In some embodiments, the mattress further comprises a central section; and the at least one inflatable section comprises a first inflatable section, the first inflatable section being a lateral extension section disposed on a lateral side of the central section, the lateral extension section being selectively inflated to adjust a width of the mattress.

In some embodiments, the lateral extension section is a first lateral extension section disposed on a first lateral side of the central section; the at least one inflatable section comprises a second inflatable section, the second inflatable section being a second lateral extension section disposed on a second lateral side of the central section, the second lateral extension section being selectively inflated to adjust the width of the mattress.

In some embodiments, the first lateral extension section is fluidly connected in series with the second lateral extension section.

In some embodiments, the first and second lateral extension sections form part of a common pneumatic control zone; an inlet of the pneumatic control zone is disposed at the first lateral extension section; and an outlet of pneumatic control zone is disposed at the second lateral extension section.

In some embodiments, the at least one inflatable section comprises a central section extending along a majority of a width of the mattress; and the inflatable bladders are elongated in a lateral direction of the mattress.

According to another aspect of the present technology, there is provided a mattress for a patient support apparatus, comprising: a cover having a bottom surface and a top surface, in use, the top surface facing a patient supported by the mattress; an inflatable section comprising at least one inflatable bladder that is selectively inflated to adjust a length of the mattress, the at least one inflatable bladder being operable in: an operating state whereby the at least one inflatable bladder is inflated sufficiently to support the patient; and a collapsed state whereby the at least one inflatable bladder is deflated and is not able to support the patient; a bladder being selectively inflatable to a predetermined pressure to assist the patient in moving, in response to the bladder being inflated to the predetermined pressure, the inflatable section of the mattress being retracted in the collapsed state of the at least one inflatable bladder.

In some embodiments, the mattress further comprises a retraction system interconnecting the bladder to the cover, the retraction system causing an expansion of the bladder to translate part of the cover and the inflatable section to be moved toward a head end of the mattress.

In some embodiments, the retraction system comprises at least one retraction band extending from the bladder towards a foot end of the mattress.

In some embodiments, the inflatable section is an inflatable foot section disposed at a foot end of the mattress.

In some embodiments, a patient support apparatus comprises: a base; an upper frame operatively connected to the base; an elevation system operatively connecting the upper frame to the base; and a deck supported by the upper frame, the deck comprising a plurality of deck sections that are movable relative to each other; and the mattress supported by the deck, the patient support apparatus being movable between a plurality of positions including a flat horizontal position and a chair egress position, wherein, in response to the patient support apparatus being moved to the chair egress position: the inflatable section of the mattress being operated in the collapsed state; the bladder being operated at the predetermined pressure to assist the patient's egress from the patient support apparatus.

According to another aspect of the present technology, there is provided a mattress for a patient support apparatus, comprising: an inflatable section comprising a plurality of first bladders that are pressurized to provide support for a patient supported by the mattress; and a turning bladder that is selectively inflated in order to turn the patient toward a first lateral side of the mattress, the turning bladder being connected to at least one of the first bladders of the inflatable section, the turning bladder comprising a bladder sheet that is connected to the at least one of the first bladders, the bladder sheet and the at least one of the first bladders defining together an interior space of the turning bladder.

In some embodiments, the mattress further comprises: a cover having a bottom surface and a top surface, in use, the top surface facing the patient supported by the mattress, wherein: the inflatable section has an upper side facing the top surface and a lower side facing the bottom surface; and the turning bladder is connected to the upper side of the inflatable section.

In some embodiments, the bladder sheet is connected to first and second ones the first bladders such that the interior space of the turning bladder is defined between the bladder sheet and the first and second ones of the first bladders.

In some embodiments, the first and second ones of the first bladders are consecutive ones of the first bladders.

In some embodiments, the bladder sheet is connected to the first and second ones of the first bladders at or near opposite lateral ends thereof such that the bladder sheet extends along a majority of a width of each of the first one and the second one of the first bladders.

In some embodiments, the bladder sheet is welded to the at least one of the first bladders.

In some embodiments, the first bladders are elongated in a longitudinal direction of the mattress.

In some embodiments, the inflatable section is a support layer configured to provide support and rigidity to the mattress; the mattress further comprises a comfort layer disposed above the support layer, the comfort layer comprising a plurality of second bladders; and the turning bladder is disposed between the support layer and the comfort layer of the mattress.

In some embodiments, the second bladders are elongated in a lateral direction of the mattress.

In some embodiments, the turning bladder is a first turning bladder; the mattress further comprises a second turning bladder that is selectively inflated in order to turn the patient toward a second lateral side of the mattress, the second turning bladder being connected to at least one of the first bladders of the inflatable section; and the first turning bladder and the second turning bladder are disposed on opposite sides of a longitudinal centerplane of the mattress.

In some embodiments, the inflatable section comprises a first sheet and a second sheet that are connected to each other to define the first bladders therebetween; and the bladder sheet is connected to the first sheet to define the interior space of the turning bladder therebetween.

Embodiments of the present technology each have at least one of the above-mentioned objects and/or aspects, but do not necessarily have all of them. It should be understood that some aspects of the present technology that have resulted from attempting to attain the above-mentioned objects may not satisfy these objects and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view, taken from a top, left side, of a mattress according to an embodiment of the present technology, shown with a patient lying on the mattress;

FIG. 2 is a perspective view, taken from a top, right side, of a patient support apparatus configured to support the mattress of FIG. 1;

FIG. 3 is a right side elevation view of the patient support apparatus of FIG. 2, showing the patient support apparatus in a chair egress position;

FIG. 4 is a perspective view, taken from a top, left side of the mattress of FIG. 1, with a top portion of a cover of the mattress removed to expose the internal components of the mattress;

FIG. 5 is a top plan view of the mattress of FIG. 4;

FIG. 6A is a cross-sectional view of the mattress taken along line 6A-6A in FIG. 5;

FIG. 6B is a cross-sectional view of the mattress taken along the same plane as FIG. 6A, showing inflatable lateral extensions of the mattress in a collapsed state;

FIG. 6 C is a cross-sectional view of the mattress taken along the same plane as FIG. 6A, showing a left turning bladder of the mattress in an inflated state;

FIG. 7A is a perspective view, taken from a top, left side of an assembly including an inflatable central section and two inflatable lateral extensions of the mattress of FIG. 4;

FIG. 7B is a cross-sectional view of part of one of the lateral inflatable lateral extensions taken along line 7B-7B in FIG. 7A;

FIG. 8 is a left side elevation view of the assembly of FIG. 7A;

FIG. 9 is an elevation view from a head end of the assembly of FIG. 7A;

FIG. 10 is a cross-sectional view of the inflatable central section of the mattress taken along line 10-10 in FIG. 7A, showing a first inflation state of upper and lower bladders of the central section;

FIG. 11 is a cross-sectional view of the inflatable central section of the mattress taken along a same plane as FIG. 10, showing a second inflation state of the upper and lower bladders of the central section;

FIG. 12 is a cross-sectional view of a part of an air loss layer fixed and part of an upper bladder of the inflatable central section of FIG. 11;

FIG. 13 is a top plan view of an assembly of two sheets of the inflatable central section of the mattress of FIG. 1, shown in a manufacturing step of the inflatable central section;

FIG. 14 is a perspective view, taken from a top, left side, of a bottom portion of a cover and a dorsal push bladder of the mattress of FIG. 1, showing the dorsal push bladder in a collapsed state; and

FIG. 15 is a perspective view, taken from a top, left side, of the assembly of FIG. 14, showing the dorsal push bladder in an inflated state thereof.

### DETAILED DESCRIPTION

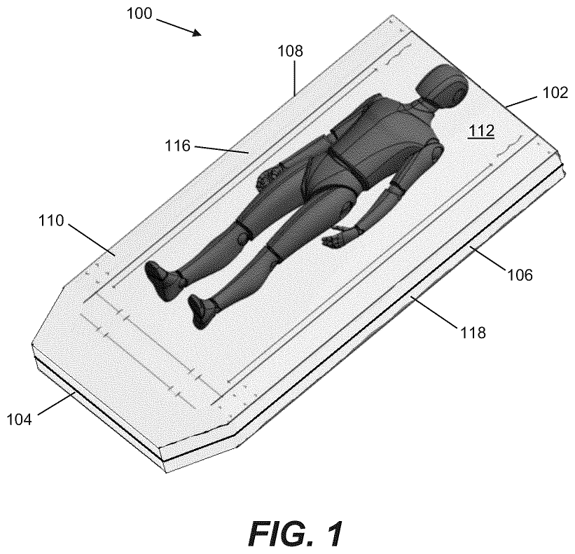

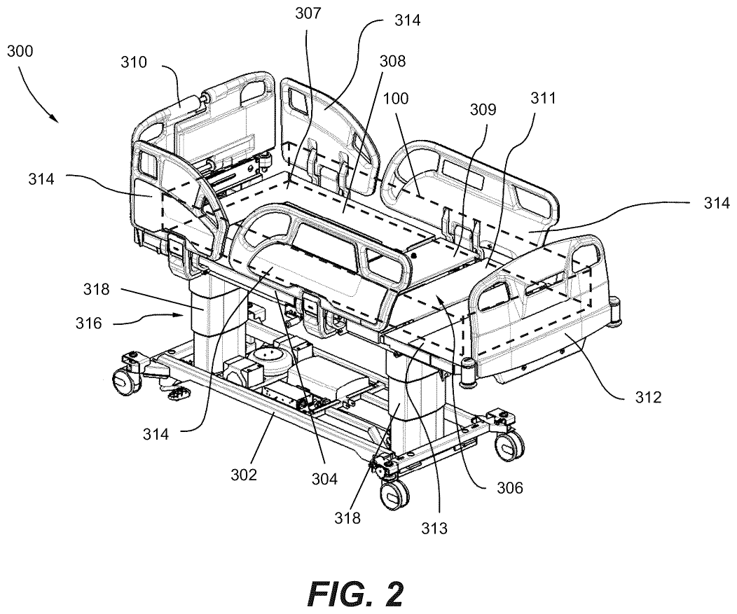

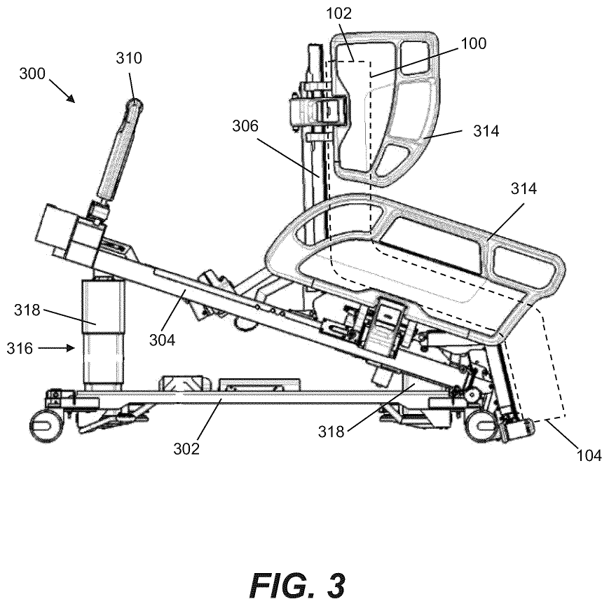

A mattress 100 in accordance with an embodiment of the present technology is illustrated in FIG. 1. The mattress 100 may be used in a medical setting to comfortably support a patient thereon. The mattress 100 may alternatively be referred to as a “patient support”. As shown in FIGS. 2 and 3, the mattress 100 may be used in conjunction with a patient support apparatus 300 such as a hospital bed. As will be explained in greater detail below, the mattress 100 is constituted in part by multiple inflatable bladders that are selectively pressurized to varying degrees to provide different features to the mattress 100, such as different treatments, movement facilitation and/or compatibility with certain functions of the patient support apparatus 300 amongst others.

With reference to FIGS. 2 and 3, in this embodiment, the patient support apparatus 300 is a hospital bed intended for use in an intensive care unit (ICU). As such, the bed 300 has advanced functions that are typically not available in an ordinary hospital bed. Nevertheless, it is contemplated that, in other embodiments, the bed 300 may be an ordinary hospital bed that does not have all the advanced functions expected from an ICU hospital bed. The bed 300 has a base 302, an upper frame 304 operatively connected to the base 302, and a deck 306 connected to the upper frame 304. The deck 306 includes multiple deck sections 307, 309, 311, 313 that are movable relative to each other and define a surface 308 of the deck 306 on which, in use, the mattress 100 is supported. The bed 300 also has a headboard 310 at a head end thereof and a footboard 312 at a foot end thereof. A plurality of siderails 314 is also provided on which one or more user interfaces (e.g., a graphic display such as a touch screen) may be provided to allow a user (e.g., a medical practitioner) to control certain functions of the bed 300 and/or the mattress 100 as well as to access information relating to the bed 300, the mattress 100 and/or the patient.

An elevation system 316 operatively connects the upper frame 304 to the base 302 and allows adjustment of the height of the upper frame 304. In this embodiment, the elevation system 316 includes two lift columns 318 that are longitudinally spaced from each other. Each lift column 318 includes an actuator (not shown) that is operable to adjust the height of the lift column 318. The height of the lift columns 318 may be adjusted separately in such that the head end and foot end of the upper frame 104 is set at different heights. As such, the bed 300 may be set to different positions including a flat horizontal position (shown in FIG. 2), also known as the bed position, a Trendelenburg position, a reverse Trendelenburg position, a cardiac chair position, and a chair egress position (shown in FIG. 3), amongst others.

The bed 300 also has an adjustable length, by selectively extending and retracting a foot deck section of the deck 306, and an adjustable width by selectively extending and retracting slidable panels from each side of one of the deck sections of the deck 306. Notably, in this embodiment, the bed 300 is designed to be used by bariatric patients which typically will need a bed with a larger width due to their size.

A more complete description of the construction and features of the bed 300 may be found in International Patent Application Publication No. WO2023/002370A1, published on Jan. 26, 2023, the entirety of which is incorporated by reference herein.

The bed 300 may be configured differently in other embodiments. For instance, in some embodiments, the elevation system 316 may instead have a head end lift assembly and a foot end lift assembly, each having a generally inverted-Y shape and including a lift leg which has a lower end that is slidably connected to the base 302. In such an example, the head end and foot end lift assemblies are selectively collapsible to adjust the height of the upper frame 304.

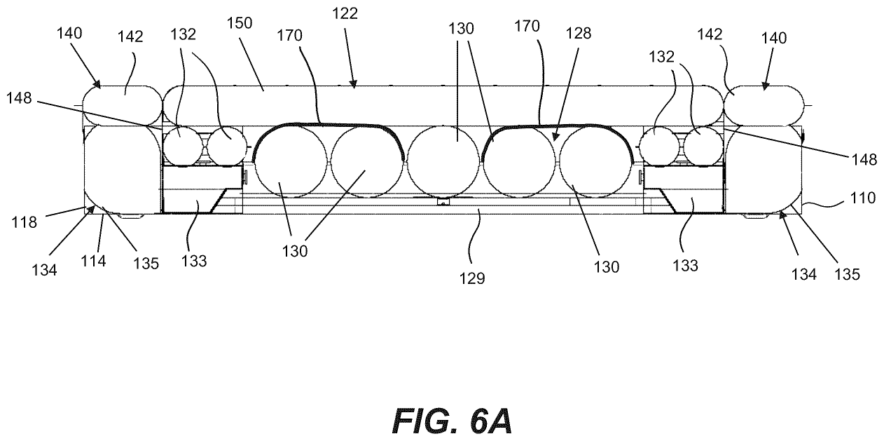

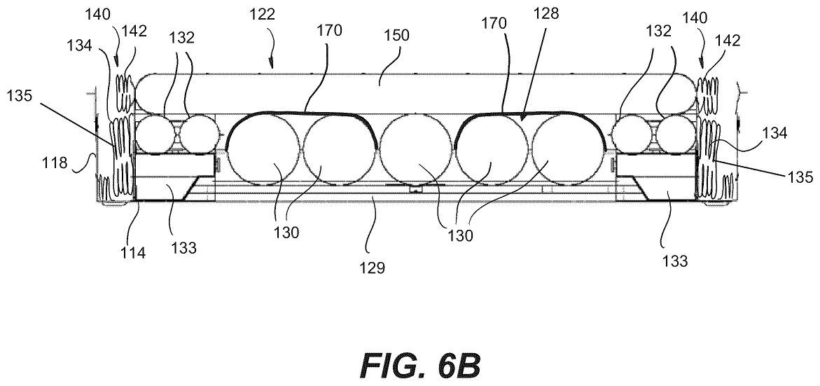

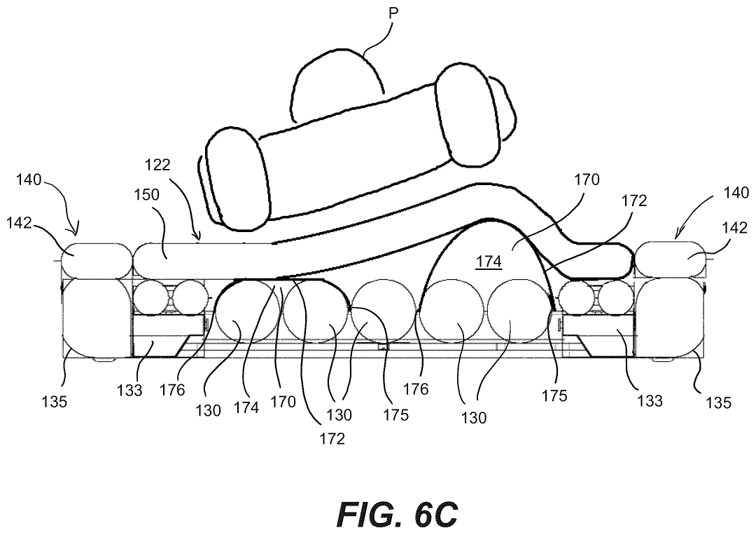

The mattress 100 will now be described with reference to FIGS. 1 and 4 to 6A. As shown in FIG. 1, the mattress 100 extends longitudinally from a head end 102 to a foot end 104 and extends laterally from a left end 106 to a right end 108. A length of the mattress 100 is defined between the head 102 and the foot end 104, while a width of the mattress 100 is defined between the left and right ends 106, 108. The mattress 100 has a cover 110 that defines the exterior surfaces of the mattress 100. Notably, the cover 110 has a top surface 112 on which the patient is supported, and a bottom surface 114 (FIG. 6A) opposite the top surface 112. A thickness of the mattress 100 is defined between top and bottom surfaces 112, 114. In this embodiment, the top surface 112 is permeable to moisture and impermeable to air. In other embodiments, the top surface 112 may be permeable to air and impermeable to moisture. In use, the bottom surface 114 is in contact with the deck 306 of the bed 300. In this embodiment, the cover 110 has a top portion 116 and a bottom portion 118 that are held together via a fastening system to contain the internal components of the mattress 100 that are disposed between the top and bottom surfaces 112, 114. In this example, the fastening system is a slide fastener (i.e., a zipper) that holds at least part of the top and bottom portions 116, 118 of the cover 110 together. Other types of fastening systems are also contemplated.

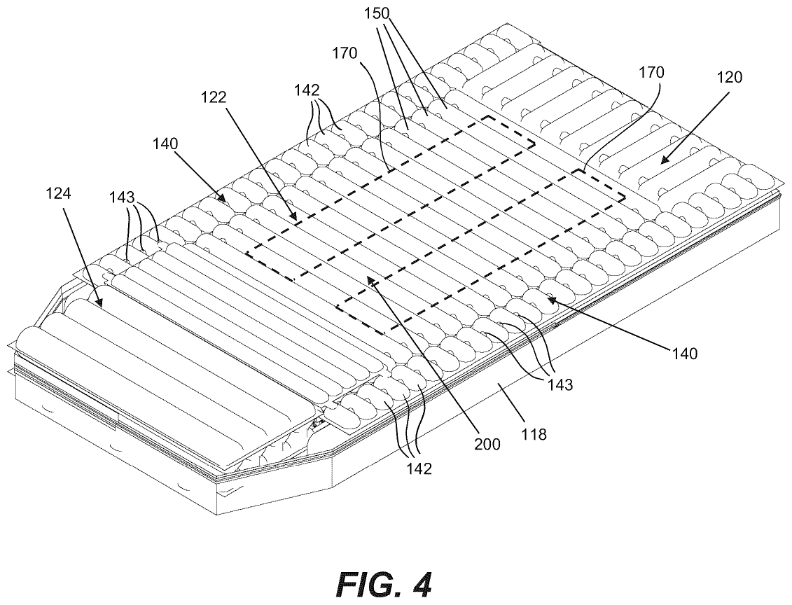

Some of the internal components of the mattress 100 are shown in greater detail in FIGS. 4 to 9. As may be seen, the mattress 100 has a multitude of inflatable sections that are selectively inflated and deflated to varying degrees in accordance with a desired configuration and/or function of the mattress 100. In particular, the mattress 100 has an inflatable head section 120 for supporting the patient's head, an inflatable central section 122 for supporting the patient's torso and upper legs, and an inflatable foot section 124 for supporting the patient's calves and feet. In this embodiment, the inflatable foot section 124 partly overlaps the inflatable central section 122.

As shown in FIG. 6A, the mattress 100 also has a central support section 128 disposed underneath the inflatable central section 122 to provide more rigidity to the mattress 100. As such, the central support section 128 may be described as a support layer while the inflatable central section 122 may be described as a comfort layer as it is generally softer than the support section 128. In this embodiment, the support section 128 is also inflatable as it includes a plurality of support bladders 130 that are inflated and deflated according to a desired rigidity of the mattress 100. That is, the pressure within the support bladders 130 is regulated to provide adequate rigidity to the mattress 100 as may be necessary. In this embodiment, the support bladders 130 are elongated and extend longitudinally. Furthermore, in this embodiment, the support bladders 130 are formed by two sheets, an upper sheet and a lower sheet, that are connected to each other (e.g., welded to each other) to define the support bladders 130 therebetween. The support bladders 130 are in fluid communication with each other such that they form a common pneumatic control zone.

It is contemplated that the support section 128 could be configured differently in other embodiments. For instance, in some embodiments, the support section 128 could instead include one or more foam members.

With reference to FIG. 4, in this embodiment, left and right turning bladders 170 (schematically illustrated in FIG. 4) are provided to turn a patient toward either lateral side of the mattress 100. More specifically, the left and right turning bladders 170 are selectively inflated to turn the patient toward the right and left sides of the mattress 100 respectively. As shown in FIGS. 6A to 6C, in this embodiment, the left and right turning bladders 170 are disposed between the central support section 128 and the central inflatable section 122. In other words, the turning bladders 170 are disposed above the central support section 128 and below the central inflatable section 122. The left and right turning bladders 170 are disposed on opposite sides of a longitudinal centerplane of the mattress 100 (i.e., a vertical plane bisecting the width of the mattress 100) and, as shown in FIG. 4, each of the left and right turning bladders 170 extends along a torso portion of the mattress 100 (i.e., a portion of the mattress 100 that will generally be aligned with the torso of the patient) as well as part of a seat portion of the mattress 100. The turning bladders 170 could extend along a greater span of the length of the mattress 100 in other embodiments (e.g., also along a head portion and/or a foot portion of the mattress 100).

FIG. 6C illustrates the left turning bladder 170 in an inflated state whereby a predetermined inflated pressure is reached within the left turning bladder 170 such that a size of the turning bladder 170 is adequate for turning a patient P toward the right side of the mattress 100. It will be understood that the outline of the patient P has been drawn for reference only in FIG. 6C for ease of understanding and does not necessarily correspond to the position of the patient P, namely as the feet of the patient would not be visible along the plane in which FIG. 6C is shown. As may be seen, when the left turning bladder 170 is inflated, the right turning bladder 170 is in a deflated state whereby the right turning bladder 170 is maintained at a predetermined deflated pressure. In the deflated state, the right turning bladder 170 has a low profile and does not significantly affect the position of the other components of the mattress 100. As will be appreciated, conversely, when the right turning bladder 170 is in the inflated state, the left turning bladder 170 is in the deflated state. Otherwise, when it is not required to turn the patient toward either side, both the left and right turning bladders 170 may be in the deflated state (as shown in FIGS. 6A, 6B).

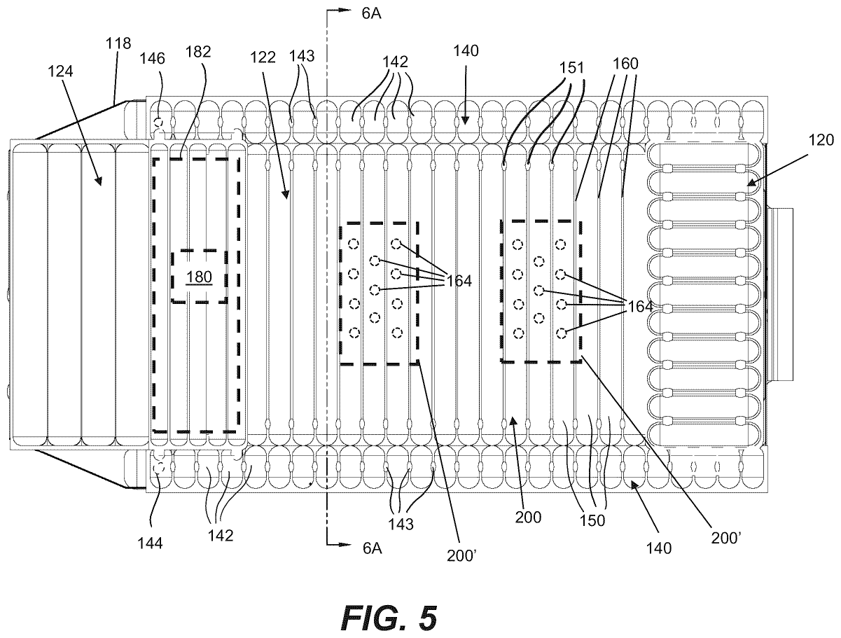

A pneumatic system is in fluid communication with the turning bladders 170 to route air to and from the turning bladders 170 as well as to other inflatable parts of the mattress 100 (including for example the support bladders 130). In particular, with reference to FIG. 5, the pneumatic system includes a pump unit 180 (shown schematically in FIG. 5) that is in fluid communication with the turning bladders 170 to control the pressure therein, thereby selectively inflating either of the turning bladders 170. In this embodiment, the pump unit 180 includes a blower disposed within a housing 182 that is disposed underneath the central support section 128. The housing 182 and the pump unit 180 may be positioned elsewhere in other embodiments. In some embodiments, the pump unit 180 may include more than one blower that are fluidly connected in series. A plurality of valves may be contained within the housing 182 in order to control the air flow into and out of the turning bladders 170. It is contemplated that, in some embodiments, the pump unit 180 may be external to the mattress 100. That is, the pump unit 180 may not be part of the mattress 100. For example, the pump unit 180 may be connected to the bed 300.

A controller (not shown) is in communication with the pump unit 180 to control the operation of the pump unit 180 based on one or more user inputs. Notably, a user interface (not shown), such as a touch screen and/or buttons on the bed 300, may be operable by a user to receive inputs therefrom and communicate corresponding signals to the controller of the pneumatic system.

In this embodiment, each turning bladder 170 is connected to the central support section 128. In particular, each turning bladder 170 includes a bladder sheet 172 (best shown in FIG. 6C) that is connected to one or more of the support bladders 130 of the central support section 128 such that an interior space 174 of the turning bladder 170 is defined by the bladder sheet 172 and the exterior surfaces of one or more support bladders 130. Notably, the interior space 174 of the turning bladder 160 is defined between the upper sheet of the central support section 128 and the bladder sheet 172. In this example, the bladder sheet 172 of each turning bladder 170 is connected to two of the support bladders 130. More specifically, the bladder sheet 172 is connected to opposite lateral sides of two of the support bladders 130. In particular, as shown in FIG. 6C, a left lateral end 175 of the bladder sheet 172 is connected to one of the support bladders 130 at or near a left lateral end of the support bladder 130, and a right lateral end 176 of the bladder sheet 172 is connected to a consecutive one of the support bladders 130 at or near a right lateral end thereof. As may be seen, the bladder sheet 172 therefore extends along a majority of a width of each of the support bladders 130 to which it is connected.

In this embodiment, the bladder sheet 172 of each turning bladder 170 is made of a polymeric material, such as a thermoplastic. Furthermore, in this embodiment, the bladder sheet 172 is welded to the support bladders 130 (e.g., via radio-frequency welding). It is contemplated that the bladder sheet 172 could be joined to the support bladders 130 via an adhesive or any other suitable method in other embodiments.

By constructing the turning bladders 170 in this manner, the turning bladders 170 are fixed in place relative to the support bladders 130, thereby minimizing shifting of the turning bladders 170 during inflation and deflation thereof.

The turning bladders 170 could be constructed separately from the support section 128 in other embodiments, or even omitted in some embodiments.

As shown in FIG. 6A, the mattress 100 also has a structural foam layer 129 disposed underneath the central support section 128.

Furthermore, with continued reference to FIG. 6A, in this embodiment, the mattress 100 has outer lateral support bladders 132 disposed laterally outwardly from the support bladders 130. Each of the outer lateral support bladders 132 sits underneath an outer lateral portion of the inflatable central section 122. The outer lateral support bladders 132 are disposed atop a respective foam support block 133 that extends longitudinally. The foam support blocks 133 may house some components such as pneumatic tubing for routing air to and from some of the inflatable sections of the mattress 100 (e.g., the inflatable head section 120). In addition, the foam support blocks 133 may provide additional rigidity to the mattress 100. As may be seen, when inflated at their operating pressure, the outer lateral support bladders 132 have a cross-sectional profile having a height that is smaller than a height of the support bladders 130 when the latter are at their operating pressure. For instance, a cross-sectional diameter of each outer lateral support bladder 132 is smaller than a diameter of each of the support bladders 130.

It is contemplated that the outer lateral support bladders 132 could be omitted in other embodiments. For instance, in some embodiments, the outer lateral support bladders 132 could instead be replaced by additional support bladders 130, and the foam support blocks 133 could be omitted.

As shown in FIGS. 4 and 5, in this embodiment, to each side of the inflatable central section 122, there is disposed a respective inflatable lateral extension 140 that spans a majority of the length of the mattress 100. The lateral extensions 140 are selectively inflated to adjust a width of the mattress 100. Notably, the lateral extensions 140 may be deflated such that respective bladders of the lateral extensions 140 collapse (as shown in FIG. 6B), thereby reducing the width of the mattress 100, and conversely the lateral extensions 140 may be inflated (as shown in FIGS. 4 to 6A) to increase the width of the mattress 100. This may be useful for example to accommodate bariatric patients. Moreover, this feature may be used in conjunction with a width extending function of the bed 300. In some embodiments, the lateral extensions 140 may be omitted (i.e., the width of the mattress 100 may not be adjustable). Each lateral extension 140 has a plurality of lateral extension bladders 142 that are disposed side-by-side in the longitudinal direction of the mattress 100. For each lateral extension 140, the lateral extension bladders 142 thereof are in fluid communication with each other via communication channels 143 defined between consecutive ones of the lateral extension bladders 142. The lateral extensions 140 will be described in greater detail further below.

As shown in FIG. 6A, the mattress 100 also has inflatable lateral support sections 134 disposed underneath respective ones of the lateral extensions 140. Each lateral support section 134 includes a plurality of lateral support bladders 135 (only one of which is shown in FIG. 6A) that are disposed side-by-side in the longitudinal direction of the mattress 100. The lateral support sections 134 provide additional rigidity to the mattress 100 at the lateral outer portions thereof when the lateral extensions 140 are deployed. To that end, the lateral support bladders 135 are selectively inflatable together with the lateral extension bladders 142 of the lateral extensions 140. In other words, the lateral support bladders 135 are inflated (as shown in FIG. 6A) together with the lateral extension bladders 142, and are deflated (as shown in FIG. 6B) together with the lateral extension bladders 142. When the lateral extensions 140 and the lateral support sections 134 are deployed, a pressure to which the lateral support bladders 135 are pressurized is greater than the pressure within the lateral extension bladders 142 in order to provide a rigid support below the lateral extension bladders 142. In some cases, the pressure in the lateral extension bladders 142 may be adjusted, namely reduced, to decrease a thickness of the mattress 100 at the lateral outer side thereof and thereby facilitate a patient exiting the bed from the side, while a pressure within the lateral support bladders 135 remains constant to provide a rigid support underneath the lateral extension bladders 142. It is contemplated that, in some embodiments, the lateral support bladders 135 could be omitted (e.g., the lateral extension bladders 142 could instead extend vertically to the level of the central support bladders 130).

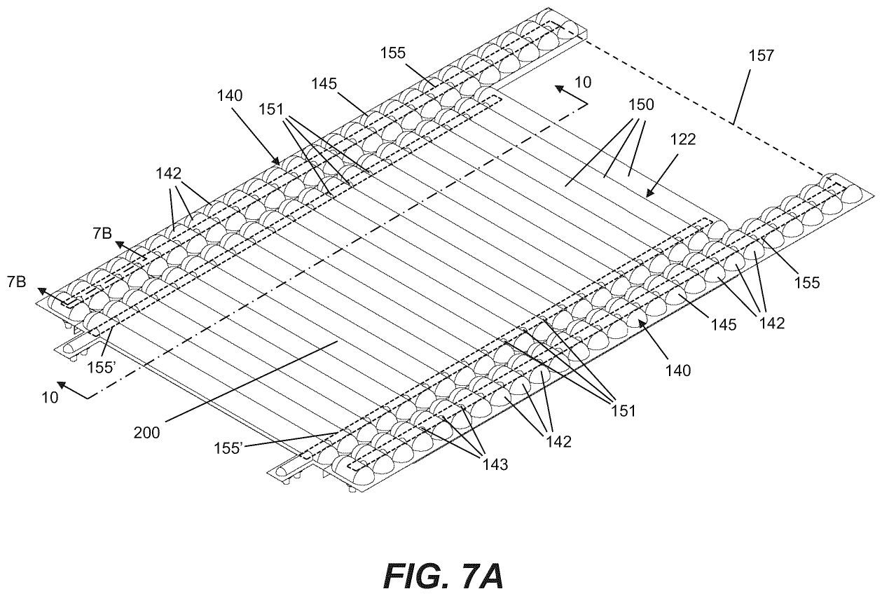

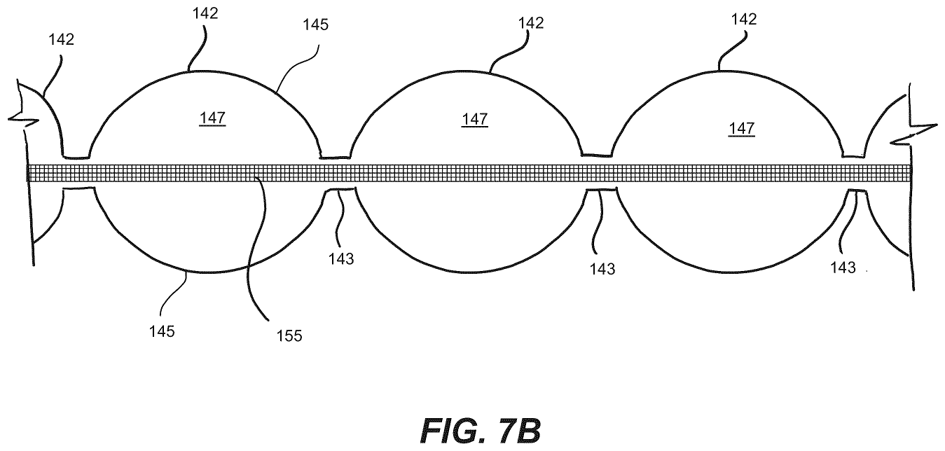

The construction of the lateral extensions 140 will now be described in greater detail with reference to FIG. 7B. In this embodiment, each lateral extension 140 is made of two sheets 145, namely upper and lower sheets 145 that are fixed (e.g., welded) to each other to define the lateral extension bladders 142 and the communication channels 143. Notably, the sheets 145 define together an internal space 147 of each of the lateral extension bladders 142 of the lateral extension 140. The upper and lower sheets 145 are made of polymeric material. In particular, in this embodiment, each sheet 145 is made of polyester layered with a thermoplastic (e.g., thermoplastic polyurethane (TPU)). For example, each sheet 145 may have a polyester core surrounded by a thermoplastic. Other material configurations of the sheets 145 are also contemplated.

In this embodiment, each lateral extension 140 also includes a spacer layer 155 disposed between the upper and lower sheets 145 and configured to separate the upper and lower sheets 145 from each other. Notably, the presence of the spacer layer 155 prevents the upper and lower sheets 145 from sticking to each other during operation which may cause restrictions to air flow within the lateral extension 140. As may be seen, the spacer layer 155 extends within the internal space 147 of each of the lateral extension bladders 142 and within the communication channels 143 extending between the lateral extension bladders 142. For instance, in this example, as best shown in FIG. 7A, the spacer layer 155 is a strip of material that extends along a majority or an entirety of the length of a corresponding one of the lateral extensions 140. The spacer layer 155 may thus have a width that is equal to or less than a width of the communication channels 143.

The spacer layer 155 is air permeable to allow air to traverse therethrough such as to minimize disruption to the air flow within the lateral extension bladders 142. As such, the inflation and deflation of the lateral extension bladders 142 is largely unaffected by the presence of the spacer layer 155. In particular, in this embodiment, the spacer layer 155 is configured to diffuse air traversing therethrough in various directions. In other words, as air flows within the lateral extension 140, the air is diffused by the spacer layer 155 in multiple directions, therefore providing optimal air distribution within the lateral extension bladders 142. In this embodiment, the spacer layer 155 is a three-dimensional (3D) fabric (also often referred to as a “3D spacer”) that is woven in three dimensions and allows air flow therethrough in multiple directions, including lateral, longitudinal and vertical directions. The 3D fabric may be made of different materials, such as nylon or polyester for example. Such 3D fabrics are available from a variety of suppliers, including for example Apex Mills Corp. amongst others. The thickness of the 3D fabric may be between 1.5 and 10 mm. In this example, the 3D fabric has a thickness of approximately 3 mm.

The spacer layer 155 may be a different type of fabric in other embodiments. For instance, in some embodiments, the spacer layer 155 may be a fleece fabric that is engineered for high breathability.

The presence of the spacer layer 155 may ensure a minimal spacing between opposite internal walls of the lateral extension bladders 142 and of the communication channels 143 such as to avoid air flow restrictions being formed along the lateral extension 140. Notably, the spacer layer 155 allows the air flow to be uninterrupted through the lateral extension 140 such that air may be routed to or away from all of the lateral extension bladders 142 in a uniform manner when the lateral extension bladders 142 are being inflated or deflated. This may prevent or otherwise minimize pressure differences along the lateral extension bladders 142.

It is contemplated that, in some embodiments, the spacer layer 155 may be omitted.

The pneumatic system is in fluid communication with the lateral extension bladders 142 to route air to and from the lateral extension bladders 142. In particular, the pump unit 180 is in fluid communication with the lateral extension bladders 142 to control the pressure therein. It is contemplated that a distinct pump unit could control the pressurization of the lateral extension bladders 142 in other embodiments.

As shown schematically in FIG. 7A, in this embodiment, the left and right lateral extensions 140 are in fluid communication with each other via a fluid connection 157 (e.g., pneumatic tubing). As shown in FIG. 5, an inlet 144 is defined at the lateral extension bladder 142 of the left lateral extension 140 that is closest to the foot end of the mattress 100, while an outlet 146 is defined at the lateral extension bladder 142 of the right lateral extension 140 that is closest to the foot end of the mattress 100. In use, when the lateral extensions 140 are deployed to increase the width of the mattress 100, the pump unit 180 routes air to the inlet 144 and the air fills the lateral extension bladders 142 of the left lateral extension 140 and then flows to the right lateral extension 140 via the fluid connection 157 and thus fills the lateral extension bladders 142 of the right lateral extension 140. As such, in this example, the left and right lateral extensions 140 are deployed or collapsed simultaneously. In other words, the left and right lateral extensions 140 form a common inflation zone.

It is contemplated that, in other embodiments, the left and right lateral extensions 140 could be fluidly independent from each other (i.e., they could be independent inflation zones) such that the left and right lateral extensions 140 could be deployed or collapsed independently from each other.

Furthermore, in this embodiment, when the lateral extensions 140 are collapsed, the pump unit 180 is controlled such as to increase the pressure within the outer lateral support bladders 132 to make them firmer. Notably, as shown in FIG. 6B, when the lateral extensions 140 are collapsed, the outer lateral support bladders 132 are closer to the lateral ends of the mattress 100 and therefore it may be desirable for the outer lateral support bladders 132 to be firmer in order to reduce potential pinching points between the mattress 100 and the bed 300.

A retraction system (not shown) may be implemented in order to retract the tissue of the lateral extensions 140 when they are deflated. For instance, the retraction system may include elastic members that cause the lateral extensions 140 to be retracted laterally when they are collapsed (i.e., deflated) in order to reduce the width of the mattress 100. The retraction system may also cause retraction of the unfilled tissue of the cover 110 to the sides of the inflatable central section 122.

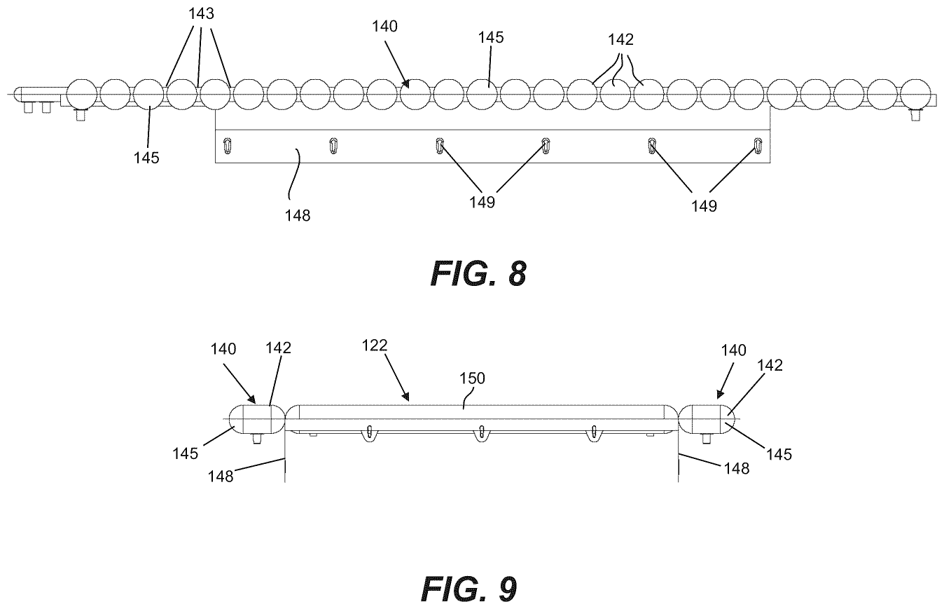

In this embodiment, the lateral extensions 140 are fixed to the inflatable central section 122. In particular, each lateral extension 140 is welded to a respective lateral side of the inflatable central section 122. As shown in FIGS. 8 and 9, each lateral extension 140 also has a fixing portion 148 that extends downwardly from an inner lateral end of the lateral extension 140. In this embodiment, each fixing portion 148 defines a plurality of openings 149 configured to receive respective fasteners (not shown). The fixing portion 148 is fixed to respective foam blocks 133 (FIG. 6A) that are fixed to the cover 110 by inserting the fasteners within the openings 149. The fixing portions 148 may be constructed differently in other embodiments.

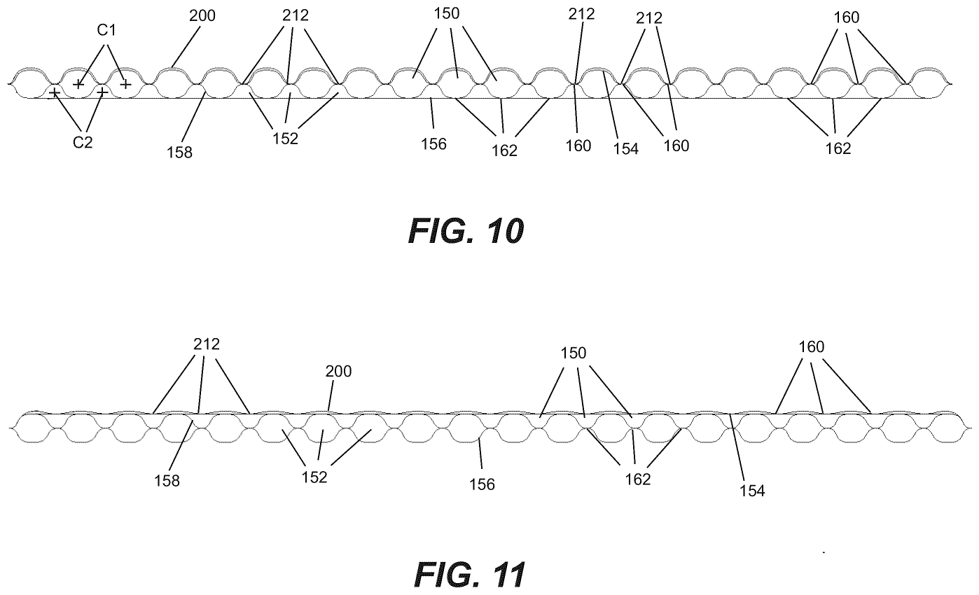

With reference now to FIGS. 10 and 11, in this embodiment, the inflatable central section 122 has a plurality of bladders 150, 152, including a plurality of first bladders 150 and a plurality of second bladders 152 that are partially vertically offset from each other. In particular, as illustrated in FIGS. 10 and 11, in a horizontal position of the mattress 100 (i.e., in a configuration in which the patient may lie on the inflatable central section 122), the first bladders 150 are aligned along a first horizontal plane while the second bladders 152 are aligned along a second horizontal plane that is disposed vertically lower from the first horizontal plane. As such, for simplicity, the first and second bladders 150, 152 will be referred to herein as upper bladders 150 and lower bladders 152 respectively.

The upper bladders 150 are in fluid communication with each other such that, when air is supplied to one of the upper bladders 150, the air also flows to the other upper bladders 150 via communication channels 151 (FIG. 7A) defined therebetween. Similarly, the lower bladders 152 are in fluid communication with each other via communication channels (not shown) defined therebetween. As will be appreciated, the upper and lower bladders 150, 152 may therefore be inflated and deflated independently from each other such that the upper and lower bladders 150, 152 may be set to different pressures. As will be described in more detail below, this may be useful to allow the inflatable central section 122 to provide an alternating pressure therapy.

As may be seen in FIGS. 7A and 9, the upper bladders 150 are elongated and extend in the lateral direction of the mattress 100 (i.e., perpendicularly to the support bladders 130). Notably, each upper bladder 150 extends along a majority of the width of the mattress 100. As such, the upper bladders 150 are disposed side-by-side in the longitudinal direction of the mattress 100. The lower bladders 152 have the same configuration as the upper bladders 150. Furthermore, the upper and lower bladders 150, 152 have a cross-sectional profile that is smaller than that of the support bladders 130. For instance, at a maximum inflation thereof, each of the upper and lower bladders 150, 152 has a height that is less than 5 inches (e.g., 2 or 3 inches), whereas the support bladders 130 have a greater height (e.g., 6 inches).

The upper bladders 150 are partially longitudinally offset from the lower bladders 152. In particular, as shown in FIGS. 10 and 11, in a longitudinal cross-section of the inflatable central section 122, a center C1 of the cross-sectional profile of each upper bladder 150 is longitudinally offset from a center C2 of the cross-sectional profile of each lower bladder 152. In particular, in this example, as shown in FIG. 10, the center C2 of each lower bladder 152 is disposed approximately longitudinally halfway between the centers C1 of two consecutive ones of the upper bladders 150. In addition, in the longitudinal cross-section of the inflatable central section 122, the centers C1 of the upper bladders 150 are disposed vertically higher than the centers C2 of the lower bladders 152. As will be appreciated, the upper and lower bladders 150, 152 are thus arranged in a staggered pattern in the longitudinal direction of the mattress 100.

As mentioned above, the upper and lower bladders 150, 152 are alternatingly pressurized in order to provide an alternating pressure function to the mattress 100. Notably, the alternating pressure function of the mattress 100 allows for continuous pressure redistribution along the inflatable central section 122 in order to prevent and/or treat pressure injuries on the patient. To that end, in this embodiment, the pressure within the upper bladders 150 and the lower bladders 152 is alternated. For instance, as illustrated in FIG. 10, the upper bladders 150 are inflated to a predetermined comfort pressure that is suitable to support the patient, while the lower bladders 152 are deflated to a reduced pressure that is less than the predetermined comfort pressure (e.g., a negative pressure). As illustrated in FIG. 11, after a preselected amount of time (e.g., 20 minutes), the reverse operation is performed whereby the upper bladders 150 are deflated to the reduced pressure and the lower bladders 152 are inflated to the predetermined comfort pressure. As will be appreciated, due to the staggered position of the upper and lower bladders 150, 152, this alternation of the pressures within the upper and lower bladders 150, 152 causes a variation of the pressure points exerted by the mattress 100 on the patient which may be beneficial to prevent or treat pressure injuries on the patient.

In this embodiment, the predetermined comfort pressure to which the upper and lower bladders 150, 152 may be inflated may be between about 4 and 32 mm Hg. In some cases, the predetermined comfort pressure may be between about 32 and 60 mm Hg. In some embodiments, the predetermined comfort pressure may be variable based on one or more inputs (e.g., a position of the bed 300, inputs related to the patient such as his/her weight, a comfort setting, etc.). Furthermore, in this embodiment, the reduced pressure to which the upper and lower bladders 150, 152 is reduced is a negative pressure (i.e., a vacuum). Other values of the reduced pressure are also contemplated.

The pneumatic system of the mattress 100 routes air to and from the upper and lower bladders 150, 152. Notably, the pump unit 180 is in fluid communication with the upper and lower bladders 150, 152 in order to control the pressure therein. In this example, the pump unit 180 is configured to transfer the air aspirated from the lower bladders 152 into the upper bladders 150 and vice-versa. In some embodiments, a distinct pump unit may be fluidly connected to the upper and lower bladders 150, 152.

The inflatable central section 122 may be constructed in various ways. In this embodiment, as best shown in FIGS. 10 and 11, the upper and lower bladders 150, 152 are formed by three sheets, including an upper sheet 154, a lower sheet 156 and an intermediate sheet 158 disposed between the upper and lower sheets 154, 156. In particular, the upper sheet 154 is fixed to the intermediate sheet 158 to define the upper bladders 150 therebetween. Similarly, the lower sheet 156 is fixed to the intermediate sheet 158 to define the lower bladders 152 therebetween. The intermediate sheet 158 thus separates the upper bladders 150 from the lower bladders 152. As will be appreciated, by limiting the amount of sheets defining the boundaries of the upper and lower bladders 150, 152, significant cost reductions may be realized compared to constructions that would include additional sheets. In addition, the construction of the upper and lower bladders 150, 152 with the three sheets 154, 156, 158 may also reduce the risk of a misalignment occurring between the upper and lower bladders 150, 152 as they are continuously alternatingly inflated and deflated compared to a construction that would include four sheets.

The upper, lower and intermediate sheets 154, 156, 158 are made of polymeric material (e.g., thermoplastic polyurethane (TPU) or other polymeric materials). Other material configurations of the sheets 154, 156, 158 are also contemplated.

As shown in FIGS. 10 and 11, the upper sheet 154 is joined with the intermediate sheet 158 at first joining sites 160, while the lower sheet 156 is joined with the intermediate sheet 158 at second joining sites 162 which are longitudinally offset from the first joining sites 160 in order to provide the staggered arrangement of the upper and lower bladders 150, 152. In this embodiment, the upper and lower sheets 154, 158 are welded to the intermediate sheet 158 and therefore the joining sites 160, 162 may be referred to as first and second welding sites 160, 162. As shown for the first welding sites 160 in FIG. 5, the first and second welding sites 160, 162 are generally elongated and extend laterally. The communication channels 151 between the upper bladders 150 and the communication channels (not shown) between the lower bladders 152 are defined at the end portions of the first and second welding sites 160, 162 respectively. Notably, along a portion of each axis defined by a respective first welding site 160, the upper and intermediate sheets 154, 158 are free of welds in order to define the communication channels 151 between consecutive ones of the upper bladders 150. The communication channels between the lower bladders 152 are defined in a similar manner.

In this embodiment, the sheets 154, 156, 158 are welded via radio-frequency welding. It is contemplated that other welding processes may be used in other embodiments. In some embodiments, the sheets 154, 156, 158 may not be welded and may instead be joined with each other via an adhesive.

As shown in FIG. 7A, in this embodiment, the inflatable central section 122 also has spacer layers 155′ that extend between the upper sheet 154 and the intermediate sheet 158, and between the intermediate sheet 158 and the lower sheet 156. The spacer layers 155′ have the same configuration as the spacer layer 155 described above and therefore will not be described in detail herein. Notably, each spacer layer 155′ is a strip that extends along the communication channels between consecutive ones of the upper bladders 150 and between consecutive ones of the lower bladders 152. The spacer layers 155′ may be omitted in other embodiments.

In order to manufacture the inflatable central section 122, the upper sheet 154 is overlayed with the intermediate sheet 158 and then welded thereto along the first welding sites 160. Part of the periphery of the upper and intermediate sheets 154, 158 may also be welded to each other. At this stage, the chambers that form the upper bladders 150 are partially formed, however at least one lateral side of the assembly of the upper and intermediate sheets 154, 158 has not been welded yet and therefore remains open. Next, as shown in FIG. 13, in this embodiment, a buffer 190 is inserted between the upper and intermediate sheets 154, 158 through the lateral side of the assembly that is open (i.e., the lateral side where the sheets 154, 158 have not yet been welded to each other). The buffer 190 includes multiple buffer prongs 191, each of which is inserted into a chamber that will form a respective one of the upper bladders 150. As may be seen, in this example, each buffer prong 191 extends along an entirety of the length of a respective one of the chambers that will form the upper bladders 150. The buffer prongs 191 are at least partially made of a material that is not suitable for welding to the material of the sheets 154, 156, 158. For instance, the buffer prongs 191 could have a coating of polyethylene, polytetrafluoroethylene or silicone.

In a subsequent step, the lower sheet 156 is placed on the intermediate sheet 158 and then welded thereto along the second welding sites 162 in order to at least partially form the lower bladders 152. Due to the presence of the buffer 190 between the upper and intermediate sheets 154, 158, the intermediate sheet 158 is isolated from the upper sheet 154 at the locations of the second welding sites 162, thereby avoiding the welding of the intermediate sheet 158 to the upper sheet 154 at sites aligned with the second welding sites 162. The buffer 190 is then removed from between the upper and intermediate sheets 154, 158 and the upper and lower sheets 154, 156 are welded to the intermediate sheet 158 where the sheets 154, 156, 158 remain open, namely along the lateral side from which the buffer 190 was removed. This manufacturing process allows the upper and lower bladders 150, 152 to have their staggered arrangement while avoiding having to add a layer of non-weldable material between the sheets 152, 156, 158 which would add to the cost of the mattress 100.

It is contemplated that the order of operations could be different in other embodiments. For instance, the lower sheet 156 could be welded to the intermediate sheet 158 before the upper sheet 154 is welded to the intermediate sheet 158.

In other embodiments, the inflatable central section 122 has a single layer of bladders instead of the layer of upper bladders 150 and the layer of lower bladders 152. That is, all of the bladders of the inflatable central section 122 could be vertically aligned with each other. In such embodiments, the alternating pressure function of the mattress 100 may be provided by alternatingly pressurizing every second one of the bladders such that each bladder that is pressurized to the predetermined comfort pressure is adjacent to a non-pressurized bladder.

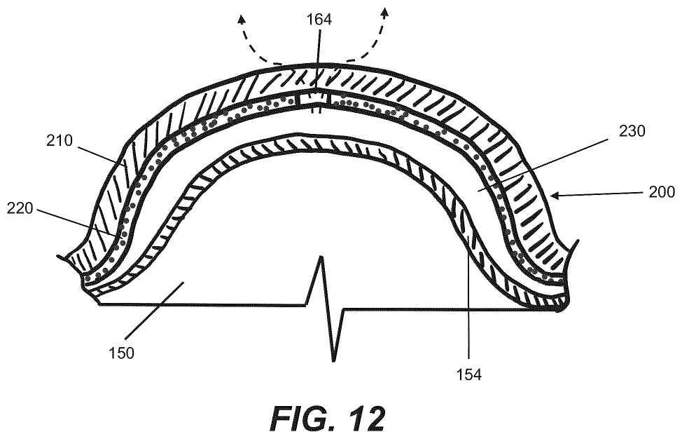

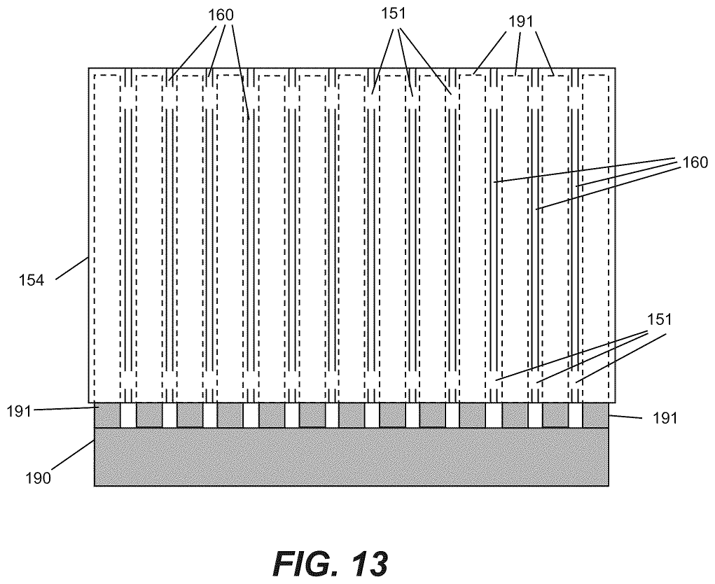

As shown in FIGS. 10 and 11, in this embodiment, the mattress 100 also has an air loss layer 200 configured to diffuse air towards the top surface 112 of the mattress 100. This may help improve patient comfort, namely by keeping the patient cool and dry or by eliminating humidity that has penetrated the mattress 100. The air loss layer 200 is disposed above the inflatable central section 122. In other words, the air loss layer 200 is disposed between the inflatable central section 122 and the top surface 112. The air loss layer 200 defines in part a plurality of air loss pockets 230 (one of which is shown in FIG. 12) that are configured to receive air therein for diffusion through the air loss layer 230. In particular, in this embodiment, the air loss pockets 230 are in fluid communication with the pump unit 180. Notably, the pump unit 180 routes air to the air loss pockets 230, the air subsequently flowing through the air loss layer 200.

With reference to FIG. 12, in this embodiment, the air loss layer 200 includes a spacer sheet 210 fixed to the upper sheet 154 of the inflatable central section 122 at a plurality of joining sites 212 (shown in FIGS. 10, 11). In this embodiment, the spacer sheet 210 is a 3D fabric that is woven in three dimensions and allows air flow therethrough in multiple directions, including lateral, longitudinal and vertical directions. Alternatively, the spacer sheet 210 may consist of other materials allowing air diffusion. For instance, in some embodiments, the spacer sheet 210 may be a different type of a fabric such as a fleece fabric that is engineered for high breathability. As may be seen in FIGS. 10 and 11, the joining sites 212 at which the spacer sheet 210 is fixed to the upper sheet 154 coincide with the joining sites 160 defined between the upper sheet 154 and the intermediate sheet 158 of the inflatable central section 122. More specifically, the joining sites 212 are superimposed with the joining sites 160. As such, the joining sites 212 between the air loss layer 200 and the upper sheet 154 are longitudinally and laterally aligned with the joining sites 160. The superposition of the joining sites 212, 160 results in the air loss layer 200 conforming to a shape of the underlying upper and lower bladders 150, 152, namely when either the upper bladders 150 or the lower bladders 152 are inflated at their predetermined comfort pressure as shown in FIGS. 10 and 11 respectively. In other words, the cross-sectional shape of the air loss layer 200 generally corresponds to the cross-sectional shape of the underlying upper and lower bladders 150, 152 as the profile of the air loss layer 200 follows the curvatures of the upper and lower bladders 150, 152. By ensuring that the air loss layer 200 conforms to the shape of the upper bladders 150, the alternating pressure functionality of the mattress 100 provided by the alternating inflation and deflation of the upper and lower bladders 150, 152 is made more efficient as the change in pressure of the bladders 150, 152 may be more readily felt by the patient's body than if the air loss layer was flat and did not conform to the shape of the bladders 150, 152. In addition, the conforming shape of the air loss layer 200 may improve patient comfort. In some embodiments, a similar air loss layer having a conforming shape to that of underlying bladders may be applied on a single row of bladders (rather than upper and lower bladders 150, 152) and have similar benefits.

In this embodiment, as shown in FIG. 12, the air loss layer 200 also includes a polymeric sheet 220 layered with and disposed below the spacer sheet 210. The polymeric sheet 220 is fixed to the upper sheet 154 of the inflatable central section 122. For instance, the polymeric sheet 220 may be adhered or otherwise fixed to the spacer sheet 210 along most or an entirety of its surface area. The polymeric sheet 220 is welded to the upper sheet 154 at the joining sites 212, which may therefore be referred to as welding sites 212. In some cases, the air loss layer 200 may be welded to the upper sheet 154 at the same time as the upper sheet 154 is welded to the intermediate sheet 158 since the welding sites 212, 160 are coincident with each other.

With reference to FIGS. 5 and 12, the polymeric sheet 220 defines a plurality of openings 164 to allow air to be discharged from the air loss pockets 230 and through the spacer sheet 210, as illustrated in FIG. 12 by arrows representing the air flow out of the air loss pockets 230. FIG. 5 illustrates some of the openings 164 in dashed lines and in exaggerated proportions for clarity. As may be seen, multiple openings 164 (e.g., two or more) may be defined at each air loss pocket 230 such that the air flowing through the air loss pocket 230 is discharged through multiple openings 164. The pattern of the openings 164 shown in FIG. 5 may be different in other embodiments. The openings 164 are of a size suitable to offer some restriction to the flow of air out of the air loss pockets 230. As such, during operation, the air loss pockets 230 fill up with some amount of air which is then discharged through the openings 164. The openings 164 may be formed in the polymeric sheet 220 in various ways. In this embodiment, the material of the polymeric sheet 220 is heated locally at the intended locations of the openings 164 in order to create the openings 164. For example, a laser heating process may be employed to create the openings 164. Thus, during manufacturing of the mattress 100, the openings 164 are formed before securing the air loss layer 200 to the upper sheet 154.

In this embodiment, the polymeric sheet 220 is made of a thermoplastic material that is weldable to the upper sheet 154. For example, the polymeric sheet 220 may be made of TPU. The polymeric sheet 220 may be made of other types of materials in other embodiments, including polymeric materials that are not readily weldable to the upper sheet 154 (e.g., being glued thereto instead).

As mentioned above, the pump unit 180 controls the air flow through the air loss pockets 230. For instance, in this embodiment, each air loss pocket 230 could have an inlet (not shown) that is fluidly connected to the pump unit 180 for receiving air therefrom. In other embodiments, the air loss pockets 230 could be fluidly connected to each other and a single inlet on one of the air loss pockets 230 could ensure that air is provided to the other air loss pockets 230. In this embodiment, the pressurization of the upper and lower bladders 150, 152 and air flow through the air loss pockets 230 are controlled independently. That is, the air flow through the air loss pockets 230 does not depend on the pressurization of the upper and lower bladders 150, 152. In other embodiments, the air loss pockets 230 could be fluidly connected in series with inflatable bladders, such as the upper and lower bladders 150, 152. In some embodiments, air flow that is routed to some inflatable sections of the mattress 100 could be rerouted to the air loss pockets 230. For instance, in some embodiments, when the lateral extensions 140 are collapsed, the air that is aspirated therefrom is discharged through the air loss pockets 230.

Furthermore, the air flow provided by the pump unit 180 through the air loss pockets 230 may be selectively started or stopped in response to a command from a control unit (not shown). The control unit may be a part of the bed 300 and in communication with the pump unit 180. For example, the control unit could be integrated in one of the siderails of the bed 300. In other embodiments, the control unit may be remote from the bed 300 (e.g., at a computer that serves as a monitoring station of one or more of the beds 300). In addition, in this embodiment, the rate of air that is routed by the pump unit 180 through the air loss pockets 230 is variable. This may be achieved for example by varying a voltage at which the pump unit 180 is operated (e.g., between 0 and 5 volts inclusively).

In this embodiment, the air loss layer 200 extends along an entirety or a majority of the surface area of the upper sheet 154 (i.e., along a majority or an entirety of the inflatable central section 122). However, it is contemplated that the air loss layer 200 may extend over a limited span of the surface area of the upper sheet 154. For instance, as shown schematically in FIG. 5, in some embodiments, one or more air loss layers 200′ with the same configuration as the air loss layer 200 extends over a part of the inflatable central section 122. For example, each air loss layer 200′ may extend over a part of the inflatable central section 122 that will, in use, be aligned with a part of the patient's body that could most benefit from the diffused air flow provided by the air loss layer 200′ (e.g., the patient's back and pelvic areas).

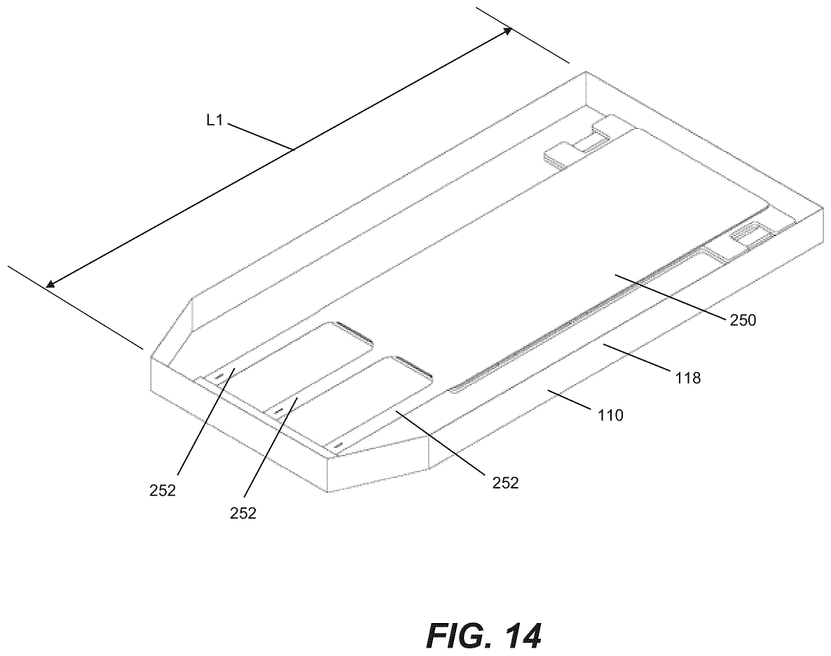

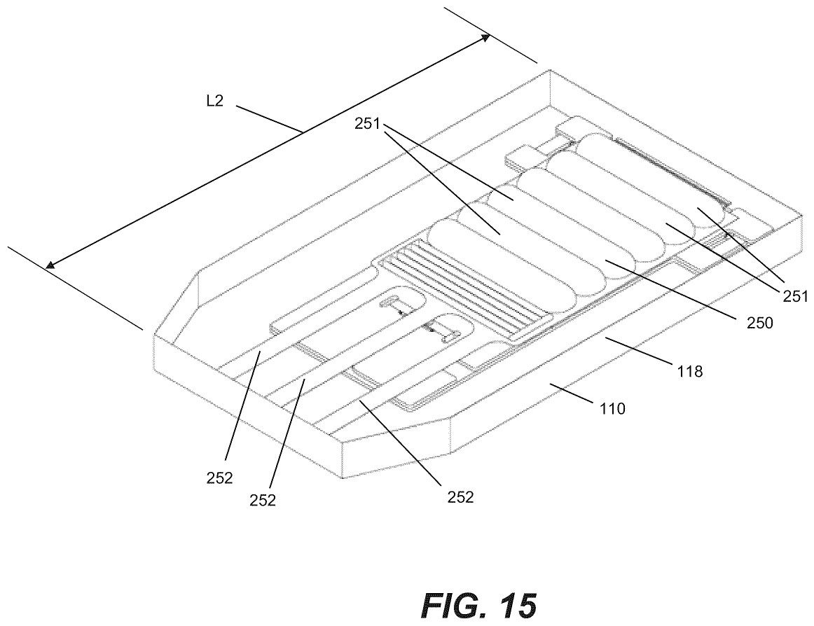

With reference to FIG. 14, in this embodiment, the mattress 100 has a dorsal push bladder 250 configured to be selectively inflated to help the patient out of the mattress 100. More specifically, the dorsal push bladder 250 is inflated in response to the bed 300 moving to its chair egress position (FIG. 3) in order to assist the patient to move forward when he/she is exiting the bed 300 from the chair egress position. The dorsal push bladder 250 may be disposed underneath the central support section 128 and extends along part of the mattress 100, including for example a torso portion of the mattress 100 (i.e., the part of the mattress 100 intended to be aligned with a torso of the patient). As shown in FIG. 15, which shows the dorsal push bladder 250 in an inflated state, the dorsal push bladder 250 has multiple cells 251 that are disposed side-by-side in the longitudinal direction of the mattress 100. The cells 251 are elongated in the lateral direction of the mattress 100. The dorsal push bladder 250 is fixed to the cover 110, namely to the bottom portion 118 thereof, around a location of the cells 251.

The dorsal push bladder 250 is in fluid communication with the pump unit 180 in order to receive air therefrom. It is contemplated that, in other embodiments, a distinct pump unit may be provided to inflate the dorsal push bladder 250.

A retraction system interconnects the dorsal push bladder 250 to the cover 110. In this embodiment, the retraction system includes three retraction bands 252 that are connected to the dorsal push bladder 250 and extend towards the foot end 104 of the mattress 100 therefrom. In this embodiment, the retraction bands 252 are integrally connected to the dorsal push bladder 250 such that they form an integral part thereof. In other words, the retraction bands 252 and the dorsal push bladder 250 are made of a continuous material. In other embodiments, the retraction bands 252 may be fastened to the dorsal push bladder 250 (e.g., via welding, gluing, or sewing). The retraction bands 252 are fixed to the cover 110 of the mattress 100 in any suitable way. In particular, the ends of the retraction bands 252 that are closest to the foot end 104 are welded, glued or sewn to the bottom portion 118 of the cover 110.

In this embodiment, the pressurization of the dorsal push bladder 250 to a predetermined activation pressure corresponding to the inflated state thereof shown in FIG. 15 causes the retraction system to retract a certain amount of excess tissue of the mattress 100. In particular, in this example, when the bed 300 transitions to the chair egress position, the inflatable foot section 124 of the mattress 100 is collapsed so as not to interfere with the ground as the foot end 104 of the mattress 100 gets closer to the ground. Therefore, the inflatable foot section 124 and the cover 110 which now contains the collapsed bladders of the inflatable foot section 124 have, in the collapsed state of the inflatable foot section 124, loose tissue. If not properly managed, this loose tissue may present an obstacle for the patient to exit the bed 300 in the chair egress position. To that end, as shown in FIG. 15, when the dorsal push bladder 250 is pressurized to its predetermined activation pressure, namely when the bed 300 is moved to its chair egress position, the tissue that forms the dorsal push bladder 250 is tightened as the cells 251 expand, thereby forcing a longitudinal move of the tissue of the dorsal push bladder 250. As this occurs, the retraction bands 252 are also moved longitudinally and, since the foot ends of the retraction bands 252 are fixed to the cover 110, the retraction bands 252 pull the loose tissue of the mattress 100 toward the head end 102, thereby shortening a length of the mattress 100. In particular, as shown in FIG. 14, when the dorsal push bladder 250 is deflated, a length L1 is defined between the head end 102 and foot end 104 of the mattress 100, while a shorter length L2 is defined between the head end 102 and foot end 104 of the mattress 100 when the dorsal push bladder 250 is pressurized to its predetermined activation pressure.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A mattress for a patient support apparatus, comprising:
a cover having a bottom surface and a top surface, in use, the top surface facing a patient supported by the mattress; and
an inflatable section disposed between the bottom surface and the top surface, the inflatable section comprising a plurality of bladders, the plurality of bladders comprising:
a plurality of upper bladders in fluid communication with each other; and
a plurality of lower bladders in fluid communication with each other,
the upper bladders being selectively inflated independently from the lower bladders,
the upper and lower bladders being formed by three sheets including an upper sheet, a lower sheet disposed below the upper sheet, and an intermediate sheet disposed between the upper and lower sheets,
the upper sheet being fixed to the intermediate sheet to define the upper bladders between the upper sheet and the intermediate sheet,
the lower sheet being fixed to the intermediate sheet to define the lower bladders between the lower sheet and the intermediate sheet.

2. The mattress of claim 1, wherein each of the upper and lower bladders is elongated in a lateral direction of the mattress.

3. The mattress of claim 1, wherein each of the upper and lower bladders spans a majority of a width of the mattress.

4. The mattress of claim 1, wherein:
the upper sheet is welded to the intermediate sheet at first weld sites to form the upper bladders;
the lower sheet is welded to the intermediate sheet at second weld sites to form the lower bladders; and
the first weld sites are longitudinally offset from the second weld sites.

5. The mattress of claim 4, wherein:
the first weld sites between any two consecutive ones of the upper bladders extend along a first axis, the upper sheet and the intermediate sheet being free of welds along at least a portion of the first axis to allow fluid communication between the two consecutive ones of the upper bladders; and
the second weld sites between any two consecutive ones of the lower bladders extend along a second axis, the lower sheet and the intermediate sheet being free of welds along at least a portion of the second axis to allow fluid communication between the two consecutive ones of the lower bladders.

6. The mattress of claim 1, further comprising:
a pneumatic system comprising a pump unit in fluid communication with the upper and lower bladders; and
the pneumatic system being operable to alternate a pressure within the upper and lower bladders to provide an alternating pressure function to the mattress.

7. The mattress of claim 1, wherein:
the mattress further comprises an inflatable support section disposed below the inflatable section; and
the inflatable support section comprises a plurality of support bladders, the support bladders being pressurized independently from the upper and lower bladders.

8. The mattress of claim 7, wherein:
each of the upper and lower bladders has a first height measured at a maximum inflation thereof;
each of the support bladders has a second height measured at a maximum inflation thereof; and
the second height is greater than the first height.

9. The mattress of claim 8, wherein the first height is less than 5 inches.

10. The mattress of claim 7, further comprising a structural foam layer disposed beneath the inflatable support section.

11. The mattress of claim 1, further comprising an air loss layer disposed between the inflatable section and the top surface, the air loss layer being configured to diffuse air toward the top surface.

12. The mattress of claim 11, wherein the air loss layer comprises a spacer sheet that is disposed above the upper sheet and is fixed thereto.

13. The mattress of claim 12, wherein:
the upper sheet is welded to the intermediate sheet at first weld sites to form the upper bladders;
the lower sheet is welded to the intermediate sheet at second weld sites to form the lower bladders;
the first weld sites are longitudinally offset from the second weld sites;
the air loss layer is welded to the upper sheet at third weld sites; and
the first weld sites and the third weld sites are superimposed.

14. A method for manufacturing a mattress for a patient support apparatus, the method comprising:
providing three polymeric sheets including a first sheet, a second sheet and a third sheet;
joining the first sheet to the second sheet along first joining sites to form at least in part a plurality of first bladders defined between the first sheet and the second sheet, the first bladders being in fluid communication with each other and positioned side-by-side in a given direction; and
joining the third sheet to the second sheet along second joining sites that are offset from the first joining sites along the given direction thereby forming at least in part a plurality of second bladders defined between the third sheet and the second sheet, the second bladders being in fluid communication with each other and positioned side-by-side in the given direction.

15. The method of claim 14, wherein:
joining the first sheet to the second sheet comprises welding the first sheet to the second sheet, the first joining sites being first welding sites;
joining the third sheet to the second sheet comprises welding the third sheet to the second sheet, the second joining sites being second welding sites; and
the method further comprises:
after welding the first sheet to the second sheet and prior to welding the third sheet to the second sheet, inserting a buffer between the first sheet and the second sheet to prevent welding the first sheet to the second sheet along the second welding sites; and
after welding the third sheet to the second sheet, removing the buffer from between the first and second sheets.

16. The method of claim 15, further comprising:
after removing the buffer from between the first and second sheets, sealing at least one peripheral side of the first, second and third sheets, including a peripheral side through which the buffer was inserted between the first and second sheets.

17. The method of claim 14, further comprising:
joining a spacer sheet to the first sheet along the first joining sites or to the third sheet along the second joining sites in order to form air loss pockets from which, in use, air may be diffused.

18. The method of claim 17, wherein the spacer sheet comprises a 3D fabric.

19. The method of claim 17, wherein:
the spacer sheet is layered with a thermoplastic sheet; and
the method further comprises:
prior to joining the spacer sheet to the first sheet or the third sheet, making openings in the thermoplastic sheet through which, in use, air in the air loss pockets may traverse before being diffused through the spacer sheet.
